(19) United States
(12) Patent Application Publication
(10) Pub. No.: US 2008/0014541 A1
(43) Pub. Date: Jan. 17, 2008

(54) Fluidizing nozzle for high capacity particulate loaders

(76) Inventors: Bob Sonntag, Swift Current Saskatchewan (CA); Paul Kerr, Swift Current Saskatchewan (CA)

Correspondence Address: KATTEN MUCHIN ROSENMAN LLP, 575 MADISON AVENUE, NEW YORK, NY, 10022-2585, US

(21) Appl. No.: 11/430,272

(22) Filed: May 8, 2006

(51) Int. Cl. F27D 15/02

(52) U.S. Cl. 432/77

(57) ABSTRACT

A fluidizer for attachment to the vacuum hose of a high capacity particulate loader, for fluidizing particulates in an area proximate an end of the vacuum hose. The fluidizer possesses a compressed air hose for providing a stream of pressurized air, which is attached to a tube, the tube being mounted upon the vacuum hose. An interior of the tube defines an air passageway therethrough. An outer surface of the tube has a plurality of air flow openings defined therein which each extend between the compressed air passageway of the tube to an area outside the tube for permitting a stream of pressurized air from the compressed air hose to flow through the air passageway of the tube and out through the plurality of air flow openings to an area proximate the end of the vacuum hose.

### FIELD OF THE INVENTION

The present invention relates to high capacity loaders for grain, particulate and granular materials (“particulates”), and particularly to fluidizing nozzles for high capacity particulate loaders.

### BACKGROUND OF THE INVENTION

Grain and fertilizer collector machines have been commercialized for many years, and represent the underlying technology over which the present invention is a significant improvement. Previous prior art machines have been subject to certain shortcomings which have been overcome in the present invention.

Some high capacity loaders for grain and fertilizer have used large vacuum devices to move grain, for example, from a pile or storage bin to a transport device such as a truck or trailer, and vice versa. These large vacuum devices may utilize a large container within which is located a vacuum or suction device which draws air and particulates into the container, typically through a long vacuum hose, and exhausts the air from the container. The vacuum or suction device within the container typically requires significant horsepower to drive, for example, a large fan or blower, particularly if the large vacuum device is being used to move grain or other particulates a significant distance, for example, greater than 30 meters, or up a significant height, for example greater than 10 meters. The requirement to move the grain or other particulates either a long distance, or a great height, or a combination of both, can significantly impair the quality of the suction at the active end of a length of vacuum hose. There is therefor a need to improve the effectiveness of such devices in these circumstances.

Furthermore, grain and other particulates are stored, sometimes over lengthy periods of time, in large storage bins and other containers, as a result of which the grain or other particulate material may become compacted or compressed, or the grain and other particulates may become moist or wet, whereupon the grain or particulate particles may become stuck or adhered to one another, or otherwise difficult to separate into individual particles. Utilizing a large vacuum device to both separate, lift and move the grain and particulates in these circumstances presents a significant problem, requiring the suction-effect from the grain vac to first separate, and then left and move the particulates.

There is, therefore, a need for a device which permits the grain or other particulates to be readily and substantially pre-separated from one another in an area immediately adjacent the active end of the vacuum hose in advance of and during the process of being acted upon by the vacuum device, to thereby increase the overall effectiveness of the vacuum device.

### SUMMARY OF THE INVENTION

Accordingly, one object of the present invention is to provide an improved fluidizer which permits grain or other particulates to be readily and substantially pre-separated from one another in an area immediately adjacent the active end of the vacuum hose in advance of and during the process of being acted upon by a vacuum device.

Advantageously, the present invention also provides an improved fluidizer which is simple, easy to use, and which increases the overall effectiveness of the vacuum device to which it is working in conjunction therewith.

According to one aspect of the present invention, there is provided a fluidizer for attachment to the vacuum hose of a high capacity particulate loader, for fluidizing particulates in an area proximate an end of the vacuum hose, comprising a compressed air hose; a tubular wall defining a tube having a first end adapted for selectively attaching the compressed air hose to the tube and a second end opposite the first end, the tube having a compressed air passageway therethrough from the first end to the second end; and means for attaching the tube to the vacuum hose of the high capacity particulate loader, wherein the tubular wall has a plurality of holes therethrough between the air passageway and an area outside of the tubular wall for permitting a movement of pressurized air from the compressed air passageway to an area proximate the end of the vacuum hose.

According to a further aspect of the present invention, there is provided a fluidizer for attachment to the vacuum hose of a high capacity particulate loader, for fluidizing particulates in an area proximate an end of the vacuum hose, comprising a compressed air hose for providing a stream of pressurized air; a tube having a first end adapted for selective attachment of the compressed air hose to the tube, and a second end opposite the first end, an interior of the tube defining a compressed air passageway therethrough extending from the first end to the second end, and wherein an outer surface of the tube has a plurality of air flow openings defined therein which each extend between the compressed air passageway of the tube to an area outside of the second end of the tube for permitting a movement of the stream of pressurized air from the compressed air hose through the compressed air passageway of the tube and out through the plurality of air flow openings to an area proximate the end of the vacuum hose; and means for attaching the tube to the vacuum hose.

The advantage of the present invention is that it provides an improved fluidizer which permits grain or other particulates to be readily and substantially pre-separated from one another in an area immediately adjacent the active end of the vacuum hose in advance of and during the process of being acted upon by a vacuum device.

A still further advantage of the present invention is that it provides an improved fluidizer which is simple, easy to use, and which increases the overall effectiveness of the vacuum device to which it is working in conjunction therewith.

### BRIEF DESCRIPTION OF THE DRAWINGS

A preferred embodiment of the present invention is described below with reference to the accompanying drawings, in which:

FIG. 1 is an illustration of one embodiment of the fluidizing nozzle of the present invention;

FIG. 2 is an illustration of the cross-sectional view of the end of the fluidizing nozzle of FIGS. 1 and 5;

FIG. 3 is an illustration of the cross-sectional view of an alternative embodiment of the end of the fluidizing nozzle of FIGS. 1 and 5;

FIG. 4 is an illustration of the cross-sectional view of a further alternative embodiment of the end of the fluidizing nozzle of FIGS. 1 and 5;

FIG. 5 is an illustration of an alternative embodiment of the fluidizing nozzle of the present invention with a handle and a hand activated air valve;

FIG. 5A is an enlarged view of a portion of the fluidizing nozzle illustrated in FIG. 5, in the closed position;

FIG. 5B is an enlarged view of a portion of the fluidizing nozzle illustrated in FIG. 5, in the opened position;

FIG. 6 is an illustration of an alternative embodiment of the fluidizing nozzle of the present invention with the end of the fluidizing nozzle in substantial axial alignment with the grain vac hose;

FIG. 7 is an illustration of a cross-sectional view of one embodiment of the end of the fluidizing nozzle of FIG. 6;

FIG. 8 is an illustration of a cross-sectional view of an alternative embodiment of the end of the fluidizing nozzle of FIG. 6;

FIG. 8A is an illustration of a cross-sectional view of an alternative embodiment of the end of the fluidizing nozzle of FIG. 6;

FIG. 9 is an illustration of a cross-sectional view of an alternative embodiment of the end of the fluidizing nozzle of FIG. 6;

FIG. 10 is an illustration of a cross-sectional view of an alternative embodiment of the end of the fluidizing nozzle of FIG. 6;

FIG. 11 is an illustration of an alternative embodiment of the fluidizing nozzle of the present invention with the end of the fluidizing nozzle directed back towards and in substantial axial alignment with the grain vac hose;

FIG. 12 is an illustration of a cross-sectional view of an embodiment of the end of the fluidizing nozzle of FIG. 11;

FIG. 13 is an illustration of a cross-sectional view of an alternative embodiment of the end of the fluidizing nozzle of FIG. 11; and

FIG. 14 is an illustration of a cross-sectional view of a further alternative embodiment of the end of the fluidizing nozzle of FIG. 11.

### DESCRIPTION OF THE PREFERRED EMBODIMENT

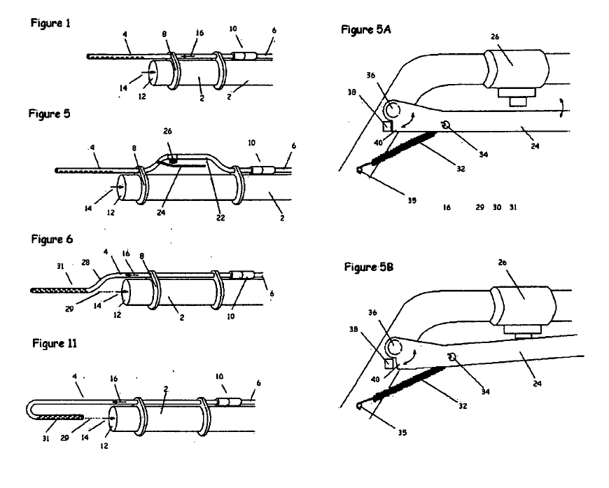

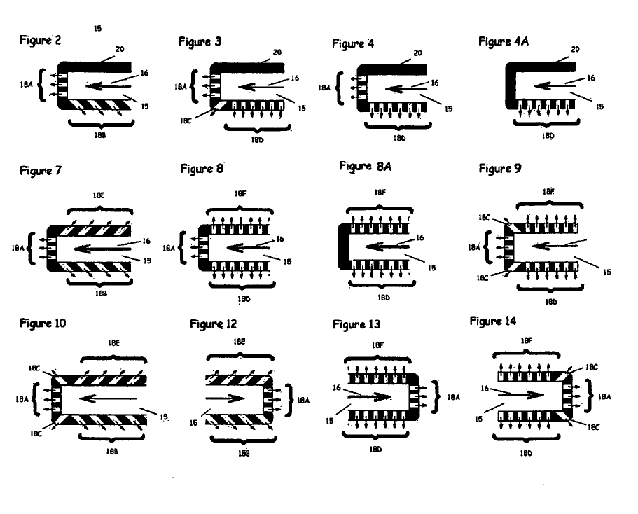

Referring to FIG. 1, a short segment of one end of a grain vac hose 2 is illustrated, the grain vac hose 2 being attachable at its other end to a grain vac (not shown) which, when the grain vac is operational, provides suction through the attached grain vac hose 2 to thereby draw particulates and air (both represented by the arrow 14) through the grain vac hose 2 and into the grain vac for subsequent handling, by way of, for example, an auger (not shown) which lifts and transports the particulates into a nearby bin or other location. In one embodiment of the present invention, a fluidizing nozzle 4 with a hollow air passageway therein, is securely attached to the grain vac hose 2 by attachments 8, which may either permanently or temporarily secure the fluidizing nozzle 4 to the grain vac hose 2, it being understood that in some circumstances it may be desirable to permanently secure the fluidizing nozzle 4 to the grain vac hose 2, whereas in other circumstances it may be desirable to remove the fluidizing nozzle 4 from the grain vac from time to time, particularly when the grain vac is being utilized in circumstances in which the fluidizing nozzle 4 is not required. It is also understood that a wide variety of mechanisms may be utilized to securely attach the fluidizing nozzle 4 to the grain vac hose 2 as would be known to a worker skilled in the art. The fluidizing nozzle 4 is attached to an air hose 6, by way of, for example, a quick connect air coupler 10, or by other means known to a worker skilled in the art, to provide a secure air tight attachment of the fluidizing nozzle to the air hose 6. The quick connect coupler 10 permits the fluidizing nozzle to be quickly attached to or detached from the air hose 6.

Pressurized air is supplied to the air passageway of the fluidizing nozzle 4 from the air hose 6 (the movement of the pressurized air in the air passageway 15 of the fluidizing nozzle being represented by the arrow 16) and thereafter passes through holes 18 in the fluidizing nozzle to an area immediately in front of or proximate the opening 12 of the grain vac hose 2. FIGS. 2, 3, 4 and 4A illustrate cross-sectional views of the end portions of four different embodiments of the fluidizing nozzle of the present invention. As represented by the arrow 16, pressurized air from the air hose 16 passes through the air passageway 15 of the fluidizing nozzle 4 and exits therefrom under pressure, in the case of the embodiment illustrated in FIG. 2, through forwardly directed holes 18A, and backwardly angled holes 18B, in the case of the embodiment illustrated in FIG. 3, through forwardly directed holes 18A, forwardly angled hole 18C, and downwardly directed holes 18D, in the case of the embodiment illustrated in FIG. 4, through forwardly directed holes 18A, and downwardly directed holes 18D, and in the case of the embodiment illustrated in FIG. 4A, through downwardly directed holes 18D. It is understood that alternative embodiments or combinations of the hole patterns may alternatively be utilized in the present invention. In each of the embodiments of the fluidizing nozzle illustrated in FIGS. 2, 3, 4 and 4A, when the fluidizing nozzle is placed in close proximity to, for example, a pile of particulates, the holes 18A, 18B, 18C and 18D permit pressurized air to be brought into contact with the particulates, to thereby partially, substantially or completely separate the particulates from each other, allowing the pressurized air to flow amongst and between the separated particulates and in the case of some particulates, to maintain the separated particulates in partial or near suspension. This permits the suction of the grain vac to act effectively upon the particulates, particularly those which are in suspension, or in a state of partial or near suspension. Additionally, to the extent that particulates were previously joined together (for example by compression, or moisture) and, by the action of the pressurized air from the fluidizing nozzle having now been separated from one another, the now-separated particulates are more readily drawn into the suction-effect of the grain vac hose.

In an alternative embodiment illustrated in FIGS. 5, 5A and 5B, the fluidizing nozzle has a handle 22 which may be utilized by the operator to support and direct the grain vac hose and fluidizing nozzle and an activatable air valve 26 which may be opened or closed by the operator to control the flow of pressurized air through the air passageway 15 to the end of the fluidizing nozzle. A hand lever 26 is also provided in this embodiment to activate/deactivate the air valve 26, the hand lever being able to rotate about a pivot 36 through a short range of motion and being biased by a spring 32 to the closed position shown in FIG. 5A. When the handle is in the closed position shown in FIG. 5A, the surface 40 of the handle abuts a stop 38 welded or otherwise securely attached to the handle which prevents further rotation in that direction. A spring 32 mounted by means of a hole 34 in the hand lever 24 and a bolt or stud 35 welded or otherwise securely fastened to the handle 22 maintains the hand lever in the closed position shown in FIG. 5A unless activated by the operator. Against the action of the spring 32, the hand lever 24 may be rotated (as shown by the arrows in FIG. 5A) by the operator about the pivot 36 to the open position illustrated in FIG. 5B in which the air valve 26 is depressed by the rotating hand lever 24 and thereby activated to permit the flow of pressurized air through the air passageway 15 to the end of the fluidized nozzle 4. It is understood that a worker skilled in the art could readily provide alternative embodiments for installing and activating/deactivating one or more air control valves suited to function in the control of the flow of pressurized air through the air passageway 15 to the end of the fluidizing nozzle. It is also understood that a handle and an air control valve may be installed on any of the embodiments of the present invention, including those shown in FIGS. 6 and 11.

Referring to FIG. 6, an alternative embodiment of the fluidizing nozzle of the present invention is illustrated, wherein the end portion 31 of the fluidizing nozzle is positioned by way of a gentle “S” bend 28 in the nozzle so as to be substantially coaxial with the longitudinal axis 29 of the grain vac hose. In the embodiment of FIG. 6, the nozzle preferably has holes such as illustrated in FIG. 7 (forwardly facing holes 18A combined with backwardly angled holes 18B and 18E), FIG. 8 (forwardly facing holes 18A combined with upwardly and downwardly directed holes 18D and 18F), FIG. 8A (upwardly and downwardly directed holes 18D and 18F), FIG. 9 (forwardly facing holes 18A combined with forwardly angled holes 18C and upwardly and downwardly directed holes 18F and 18D) and/or FIG. 10 (forwardly facing holes 18A combined with forwardly angled holes 18C and backwardly angled holes 18B and 18E), or a combination thereof it being understood that alternative embodiments of the hole patterns may alternatively be utilized in the present invention.

Referring to FIG. 11, a further alternative embodiment of the fluidizing nozzle of the present invention is illustrated, wherein the end portion 31 of the fluidizing nozzle is positioned by way of a “U” shaped bend 30 in the nozzle so as to be substantially coaxial with the longitudinal axis 29 of the grain vac hose. In the embodiment of FIG. 11, the nozzle preferably has holes such as illustrated in FIG. 12 (backwardly facing holes 18A, combined with backwardly angled holes 18B and 18E), FIG. 13 (backwardly facing holes 18A, combined with upwardly and downwardly directed holes 18F and 18D) and/or FIG. 14 (backwardly facing holes 18A, combined with backwardly angled holes 18C and upwardly and downwardly directed holes 18F and 18D), or a combination thereof it being understood that alternative embodiments of the hole patterns may alternatively be utilized in the present invention.

The fluidizing nozzle of the present invention may be made from tubular steel, aluminum, heavy gauge plastic or other material known to persons skilled in the art.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A fluidizer for attachment to the vacuum hose of a high capacity particulate loader, for fluidizing particulates in an area proximate an end of the vacuum hose, comprising:
a. a compressed air hose;
b. a tubular wall defining a tube having a first end adapted for selectively attaching the compressed air hose to the tube and a second end opposite the first end, the tube having a compressed air passageway therethrough from the first end to the second end; and
c. means for attaching the tube to the vacuum hose of the high capacity particulate loader, wherein the tubular wall has a plurality of holes therethrough between the air passageway and an area outside of the tubular wall for permitting a movement of pressurized air from the compressed air passageway to an area proximate the end of the vacuum hose.

2. The fluidizer of claim 1, wherein the second end of the tube has an end wall having a plurality of holes therethrough between the air passageway and an area outside of the end wall for permitting the movement of pressurized air from the compressed air passageway to the area proximate the end of the vacuum hose.

3. The fluidizer of claim 2, wherein each of the at least one of the holes has a longitudinal axis which is substantially perpendicular to the tubular wall at a point where the holes pass through the tubular wall.

4. The fluidizer of claim 3, wherein the at least one of the holes has a longitudinal axis which is at an angle of more than 20 degrees from perpendicular to the tubular wall at the point where the hole passes through the tubular wall.

5. The fluidizer of claim 4, wherein the at least one of the holes has an entrance on that end of the hole adjacent the air passageway, and an exit on the other end, wherein the exit of the at least one of the holes is generally directed toward the end of the vacuum hose.

6. The fluidizer of claim 4, wherein the at least one of the holes has an entrance on that end of the hole adjacent the air passageway, and an exit on the other end, and wherein the exit of the at least one of the holes is generally directed away from the end of the vacuum hose.

7. The fluidizer of claim 1 or 2, wherein the means for attaching the tube to the vacuum hose is positioned substantially proximate the first end of the tube and the plurality of holes in the tube are substantially proximate the second end of the tube.

8. A fluidizer for attachment to the vacuum hose of a high capacity particulate loader, for fluidizing particulates in an area proximate an end of the vacuum hose, comprising:
a compressed air hose for providing a stream of pressurized air,
a tube having a first end adapted for selective attachment of the compressed air hose to the tube, and a second end opposite the first end, an interior of the tube defining a compressed air passageway therethrough extending from the first end to the second end, and wherein an outer surface of the tube has a plurality of air flow openings defined therein which each extend between the compressed air passageway of the tube to an area outside of the second end of the tube for permitting a movement of the stream of pressurized air from the compressed air hose through the compressed air passageway of the tube and out through the plurality of air flow openings to an area proximate the end of the vacuum hose; and
means for attaching the tube to the vacuum hose.

9. The fluidizer of claim 8, wherein the second end of the tube has a plurality of air flow openings defined therein which each extend between the compressed air passageway of the tube to an area outside of the second end of the tube for permitting a movement of the stream of pressurized air from the compressed air hose through the compressed air passageway of the tube and out through the plurality of air flow openings in the second end of the tube to an area proximate the second end of the tube.

10. The fluidizer of claim 8, wherein the second end of the tube has at least one air flow opening defined therein which extends between the compressed air passageway of the tube to an area outside of the second end of the tube, for permitting a movement of the stream of pressurized air from the compressed air hose through the compressed air passageway of the tube and out through the at least one air flow opening in the second end of the tube to an area proximate the end of the vacuum hose.

11. The fluidizer of claim 8, wherein a longitudinal axis of the tube is parallel to a longitudinal axis of the vacuum hose.

12. The fluidizer of claim 8, wherein the second end of the tube defines at least one air flow opening therein, which extends between the compressed air passageway of the tube to an area outside of the second end of the tube for permitting a movement of the stream of pressurized air from the compressed air hose through the compressed air passageway of the tube and out through the at least one air flow opening in the second end of the tube to an area proximate the second end of the tube.

13. The fluidizer of claim 12, wherein the second end of the tube further comprises an end wall, the end wall defining the at least one air flow opening therein.

14. The fluidizer of claim 9, wherein the second end of the tube further comprises an end wall, the end wall defining the plurality of air flow openings therein.

15. The fluidizer of claim 14, wherein each of the plurality of air flow openings have a longitudinal axis which is substantially perpendicular to the end wall at a point where the plurality of air flow openings pass through the end wall.

16. The fluidizer of claim 13, wherein the at least one air flow opening has a longitudinal axis which is substantially perpendicular to the end wall at a point where the at least one air flow opening passes through the end wall.

17. The fluidizer of claim 8, wherein the plurality of air flow openings are defined through upper and lower outer surfaces of the tube.

18. The fluidizer of claim 17, wherein the plurality of air flow openings defined through the upper and lower outer surfaces of the tube are perpendicularly positioned in relation to the compressed air passageway of the tube.

19. The fluidizer of claim 8, wherein the means for attaching the tube to the vacuum hose is positioned substantially proximate the first end of the tube.

20. The fluidizer of claim 8, wherein the plurality of holes defined in the tube are positioned substantially proximate the second end of the tube.

21. The fluidizer of claim 8, wherein the means for attaching the tube to the vacuum hose further comprises at least two mounting rings connected to the tube, the mounting rings being adapted to receive and encircle the vacuum hose, whereby the tube can be mounted thereon.

22. The fluidizer of claim 21, wherein, when the tube is mounted upon the vacuum hose, the tube is positioned in parallel relationship with and above the vacuum hose.

23. The fluidizer of claim 21, wherein, when the tube is mounted upon the vacuum hose, a substantial portion of the tube is positioned in close parallel relationship with and above the vacuum hose, and the second end of the tube having the plurality of air flow openings defined therein is bent, whereby a center of the second end of the tube is axially aligned with a center of the vacuum hose.

24. The fluidizer of claim 23, wherein the second end of the tube is bent in a “U” shape towards the end of the vacuum tube.

25. The fluidizer of claim 23, wherein the second end of the tube is bent in an “S” shape away from the end of the vacuum tube.

26. The fluidizer of claim 23, wherein a substantially middle portion of the tube is bent, the substantially middle portion of the tube being positioned away from close parallel relationship with the vacuum tube so as to form a handle portion which can be grasped by a user.

27. The fluidizer of claim 26, wherein the handle portion further comprises:
an activatable air valve positioned on an underside of the handle portion wherein, when the air valve is activated, permits a flow of the stream of pressurized air through the compressed air passageway of the tube;
a hand lever hingedly connected to the substantially middle portion of the tube, the hand lever being operably able to activate the air valve when a user depresses the hand lever upwardly such that the hand lever comes into engagement with the air valve; and
spring means for biasing the hand lever to a closed position, whereby, when the user releases the hand lever, the spring means biases the hand lever in a downward direction away from the engagement with the air valve so as to deactivate the air valve.

28. The fluidizer of claim 27, wherein the hand lever is hingedly connected to the substantially middle portion of the tube about a pivot.

29. The fluidizer of claim 28, wherein the handle portion further comprises stopping means, the stopping means being connected to the substantially middle portion of the tube beneath the pivot, whereby, when the spring means biases the hand lever away from the engagement with the air valve, pivoting movement of the hand lever in the downward direction is prevented by the stopping means coming into contact with a portion of the hand lever near the hinged connection to the substantially middle portion of the tube.

30. The fluidizer of claim 29, wherein one end of the spring means is connected to the substantially middle portion of the tube, and the other end of the spring means is connected to the hand lever.
